(19) United States
(12) Patent Application Publication
(10) Pub. No.: US 2023/0396282 A1
(43) Pub. Date: Dec. 7, 2023

(54) MOBILE DEVICE CASE WITH ACCESSORY HOLDING STRUCTURE

(71) Applicant: Teddy Bob Fitzgerald Richards, II, San Francisco, CA (US)

(72) Inventor: Teddy Bob Fitzgerald Richards, II, San Francisco, CA (US)

(21) Appl. No.: 18/321,470

(22) Filed: May 22, 2023

Related U.S. Application Data
(60) Provisional application No. 63/348,481, filed on Jun. 2, 2022.

(51) Int. Cl. H04B 1/3888

(52) U.S. Cl. CPC H04B 1/3888

(57) ABSTRACT

A mobile device case 600 having an interior accessory holding structure 500, intended to hold displaying elements in such a way that the elements are displayed from the case. The interior holding structure allows both an outlining frame 400 and displaying specimen 200 to be put into and taken out of the case. The accessory holding means includes a removable support panel 100 and outlining frame 400 that fits within the holding structure supporting the displaying specimen 200 in the respective holding area. The case body 600 has a seating space to allow a mobile device to be seated therein.

### CROSS-REFERENCE TO RELATED APPLICATION

This application claims the benefit of U.S. Patent Application No. 63/348,481 filed Jun. 2, 2022, which is incorporated by reference herein in its entirety.

### BACKGROUND OF THE INVENTION

This relates generally to mobile device protective cases.

A mobile device is developed and employed to protect a device but there may be additional purposes and functions.

In adding a removable accessory to a mobile case, there may be additional personalization. Also, with many different mediums available to be displayed, there is a wide variety of added personalization that may be desirable and possible.

The addition of such accessories to a mobile device case allows for a diverse experience.

### SUMMARY

A mobile device case includes an interior accessory holding structure as to display said accessory elements. The mobile device case encases both a mobile device and said accessory elements. The accessory holding structure both holds and displays an array of accessory elements. An outlining frame element and a displaying specimen are displayed from the the rear of the device case. A removable panel with supplemental features maintains the outlining frame and specimen in place.

### BRIEF DESCRIPTION OF THE DRAWINGS

FIG. 1A A referenced front perspective view of each removable and acting element for a complete assemblage.

FIG. 1A rear view of an illustrative mobile case displaying a specimen and outlining frame.

### DETAILED DESCRIPTION OF THE DRAWINGS

Mobile device case 600 may include a device enclosure surrounding the periphery of said device and an accessory holding structure 500. The holding structure is included within the mobile device case which holds an array of elements as to display such elements. Accessory holding structure 500 is of rectangular shape and may be a variable depth.

The outlining frame 400 shown is held within the holding structure and may be of variable size, thickness, or quantity. The material of the outlining frame may be formed of planar materials such as plastic, glass, ceramic, metal, or wood.

A displaying specimen 200 shown is held within the outlining frame 400 and holding structure 500. The displaying specimen is removable, changeable, and may be of variable quantity. The displaying specimen may be of variable or standardized size.

The removable support panel 100 shown is held within the outlining frame 400. The support panel may be of variable size and thickness. The material of the support panel may be formed of planar materials such as plastic, glass, ceramic, metal, wood, or paper. The support panel may feature additional elements which include but is not limited to supplemental magnets or wireless circuitry.

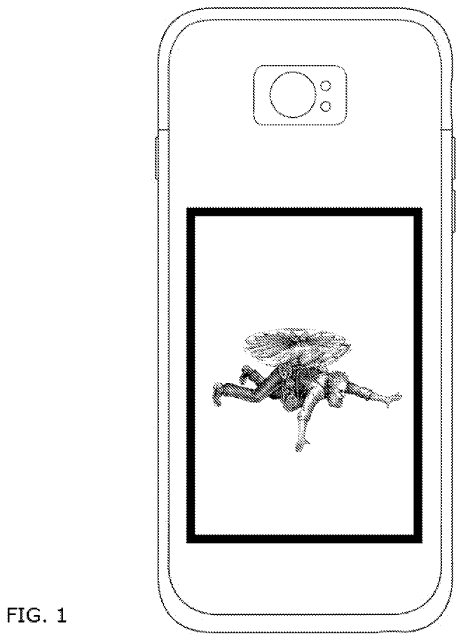

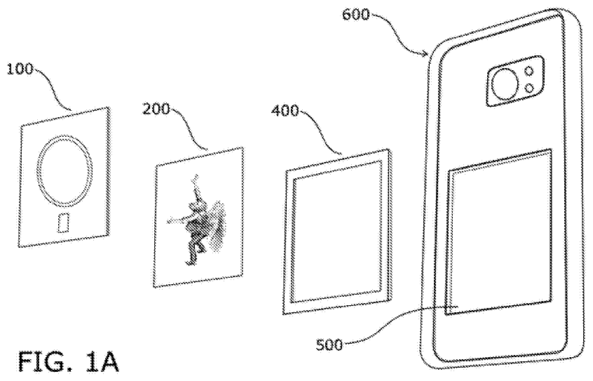

By reference shown in FIG. 1A, mobile case 600 embodies the accessory holding structure 500 with an outlining frame 400 and displaying specimen 200.

As shown in FIG. 1, mobile case 600 embodies the accessory holding structure 500 with an outlining frame 400 and displaying specimen 200.

In FIG. 1, mobile case is shown in a complete assemblage to exemplify use.

### CONCLUSION

This invention has been described in specific detail with reference to the disclosed embodiments, it will be understood that variations and modifications may be effected within the scope of the said invention as previously described.

What is claimed is:

1. A mobile device case that includes an interior accessory holding and displaying structure.

2. An accessory holding and displaying structure that includes both a removable outlining frame and removable support panel.
